(19) United States
(12) Patent Application Publication
(10) Pub. No.: US 2008/0310149 A1
(43) Pub. Date: Dec. 18, 2008

(54) Floating Electronic Candle

(76) Inventor: Boyi Chan, Taipei (TW)

Correspondence Address: LIN & ASSOCIATES INTELLECTUAL PROPERTY, INC., P.O. BOX 2339, SARATOGA, CA, 95070-0339, US

(21) Appl. No.: 11/762,776

(22) Filed: Jun. 14, 2007

(51) Int. Cl. F21L 4/00; F21V 23/04

(52) U.S. Cl. 362/186; 362/392

(57) ABSTRACT

Floating electronic candle that can simulate a fickering flame using an LED bulb or can emit a variety of different-colored lights using a color-changing LED bulb with an IC unit is able to float on a liquid, and is to turn on automatically when floating on the liquid. It has an integrated flame portion and body, a bottom cap, a plurality of batteries, a transistor, a resistor, a switch mechanism, and a plurality of trace wires, and optionally, can also have an external wax shell. The primary control mechanism is activated to turn the electronic candle on and off on demand by making use of the conductivity of the liquid in which the electronic candle is floating on.

### BACKGROUND OF THE INVENTION

1. Field of the Invention

The present invention relates generally to an electronic candle, and in particular to a floating electronic candle having a changeable simulated flame and is able to float on a liquid.

2. The Prior Arts

There are many instances where the use of a candle can be impractical, unsafe, or too expensive. It would, for example, be impermissible to use candles in places where local fire safety codes would prevent it. For example, spas and hotels would typically prefer to use safer alternatives to real candles for their guests for the sake of reducing fire hazards. Furthermore, moms and dads would prefer their children to use the safer electronic candles in lieu of the real ones for the same safety concerns. In addition, restaurants would enjoy of having candles to create romantic ambience at dining table, they are often considered to be too expensive because of having to stay lit for extended periods of time. As a result, electronic candles have been developed as a viable alternative. However, many conventional electronic candles do not simultaneously possess the following characteristics: change lighting colors on the fly; having a realistic wax body; using a power-saving LED bulb; being able to float on water; and being turned on automatically when floating on a liquid such as water. Indeed, conventional synthetic candles typically require having to turn on or off of a switch device located on the main body for activating the simulated “flame”.

To resolve the problems above, an electronic candle having a changeable simulated flicker that is able to float on a liquid is proposed.

### SUMMARY OF THE INVENTION

A primary objective of the present invention is to provide an electronic candle that changes “flame” colors on the fly, with a wax body, uses a LED bulb, to be able to float on a liquid, and is to turn on automatically when floating on the liquid.

Another objective of the present invention is to provide an electronic candle that is able to simulate a flickering flame, with a plastic body, uses a LED bulb, to be able to float on the liquid, and is to turn on automatically when floating on the liquid.

According to the objectives above, a first embodiment of the present invention for the proposed electronic candle includes a color-changing LED bulb with an IC unit, an integrated flame portion and body, an external wax shell, a bottom cap, a plurality of batteries, a transistor, a resistor, a switch mechanism, and a plurality of trace wires.

According to the objectives above, a second embodiment of the present invention for the proposed electronic candle includes an LED bulb, an integrated flame portion and body, a bottom cap, a candle flicker circuit, a battery, a transistor, a resistor, a switch mechanism, and a plurality of trace wires.

According to the objectives above, a primary control mechanism is activated to turn the electronic candle on and off on demand by making use of the conductivity of the liquid in which the electronic candle is floating on. In addition, the electronic candle can be turned off automatically when the electronic candle is removed from the liquid in which it was previously immersed in.

According to the objective above, the candle flicker circuit is coupled to the LED bulb using the wires to provide the simulating effects of a wax candle flame. In addition, the external wax shell provides the additional exact physical likeness to that of a real wax candle.

For those skilled in the art to be able to understand the objective, the character, and the effect of the present invention, the following illustrated embodiments of the present invention and together with the attached drawings serve to explain the principles of the present invention.

### BRIEF DESCRIPTION OF THE DRAWINGS

The present invention will be apparent to those skilled in the art by reading the following detailed description of a plurality of embodiments thereof, with reference to the attached drawings, in which:

FIG. 1 is a circuit diagram for an electronic candle according to a first embodiment of the present invention;

FIG. 2 is a circuit diagram for an electronic candle according to a second embodiment of the present invention;

FIG. 3 is an exploded perspective view showing the electronic candle according to the first embodiment of the present invention;

FIG. 4 is an exploded perspective view showing the electronic candle according to the second embodiment of the present invention; and

FIG. 5 is a view showing the bottom portion of the electronic candle according to the first embodiment of the present invention.

### DETAILED DESCRIPTION OF THE EMBODIMENTS

A battery as described in the present invention includes, but is not limited to, one or more of DC 1.5V-4.5V lithium battery cell or alkaline button cell.

An LED bulb as described in the present invention includes, but is not limited to, a LED bulb which emits a white, red, green, orange, yellow, white, blue, or orange-red colored light.

A color-changing LED bulb with an IC unit, as described in the present invention includes, but is not limited to, an LED bulb which emits a green, blue, and/or red colored light interchangeably.

An external wax shell as described in the present invention includes, but is not limited to, an oval-rock, a rubber duckie, a flower petal, a bubble ball, and other figurines and articles of design.

A switch mechanism as described in the present invention includes, but is not limited to, a pair of metal heads.

A liquid as described in the present invention includes, but is not limited to, water, mud, milk, essential oil solution, mineral spring, or other liquids that conducts electricity.

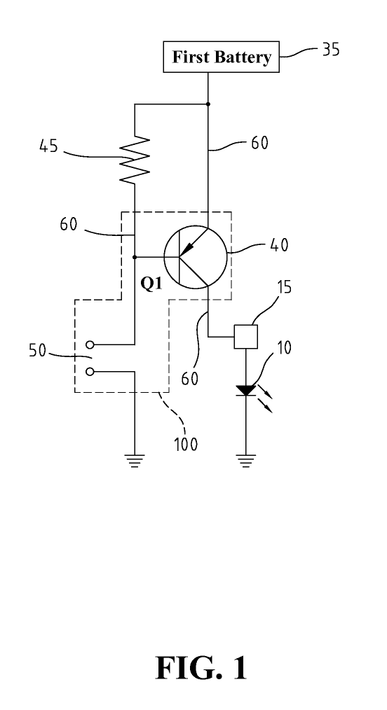

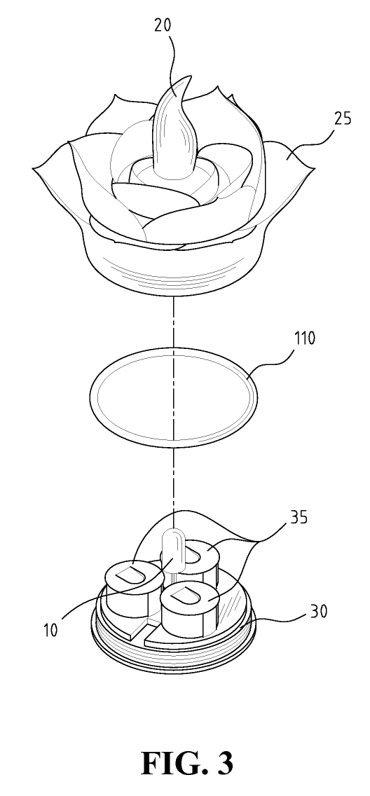

Referring to FIGS. 1 and 3, an electronic candle according to a first embodiment of the present invention includes a color-changing LED bulb 10 with an IC unit 15, an integrated flame portion and body 20, an external wax shell 25, a first bottom cap 30, a plurality of first batteries 35, a transistor 40, a resistor 45, a switch mechanism 50, and a plurality of trace wires 60.

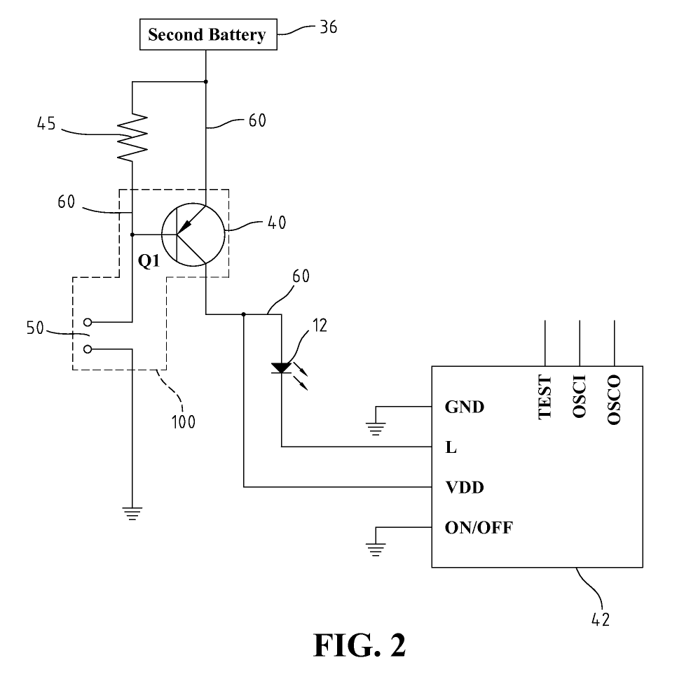

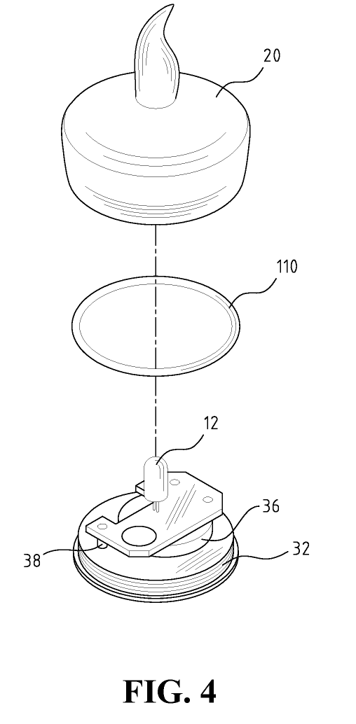

Referring to FIGS. 2 and 4, an electronic candle according to a second embodiment of the present invention includes an LED bulb 12, the integrated flame portion and body 20, a second bottom cap 32, a plurality of mounting posts 38, a candle flicker circuit 42, a second battery 36, the transistor 40, the resistor 45, the switch mechanism 50, and the trace wires 60.

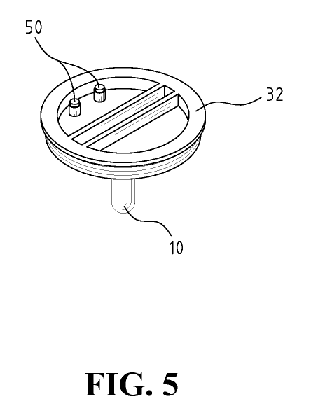

Furthermore, referring to FIGS. 3-5, according to both embodiments of the present invention, a primary control mechanism 100, comprising of the switch mechanism 50, the transistor 40, and the trace wires 60, can be activated to turn the electronic candle on and off on demand via the conductivity of the liquid in which the electronic candle is floating on. In addition, the floating electronic candle can be turned off automatically when it is removed from the liquid in which it was previously partially immersed. Indeed, as the switch mechanism 50 and the bottom portion of the floating electronic candle is fully immersed inside the liquid, a completed circuit is formed by means of the activating of the transistor 40 shown in FIGS. 1 and 2 via the electrical current at Q1. As a result, power is supplied to the color-changing LED bulb 10 with the IC unit 15 for illumination. Upon the removal of the floating electronic candle from the liquid, an open circuit is again created at the switch mechanism 50; therefore, power is then cut off to the color changing LED bulb 10, and the floating electronic candle is turned off.

Referring to FIGS. 1 and 3, in accordance with the first embodiment of the present invention, the color-changing LED bulb 10 with an IC unit 15 is able to emit green, blue, and/or red colored light continuously with a gradual smooth transition in between each color change; the integrated flame portion and body 20 can be made from a common thermoplastic material, such as PVC, PS, acrylic, or other like materials, with an opaque color such as white; the flame portion of the integrated flame portion and body 20 is protruded out of the top opening of the external wax shell 25; the external wax shell 25 can be made using a wax mold in conjunction with the typical wax candle making methods commonly known in the art; the first bottom cap 30 is a circular cap with threads on the bottom along with a sealing o-ring to prevent water leakage; the first bottom cap 30 includes a rubber o-ring 110 disposed along the inner periphery below the threaded portion; the transistor 40 can be in the form of a PNP BJT; the resistor 45 is 1M; the switch mechanism 50 can be in the form of a pair of heads on a thin nail body in which the head is protruding out corresponding to the bottom surface of the first bottom cap 30. In addition, the electronic candle according to the first embodiment of the present invention contains three 1.5V alkaline button cell batteries for use as the first batteries 35. Meanwhile, the first bottom cap 30 is a screw-on plastic cap with threads and a rubber o-ring for ensuring waterproof containment of the internal components after assembly.

Referring to FIGS. 2 and 4, in accordance with the second embodiment of the present invention, the LED bulb 12 is able to simulate a flickering behavior of a true wax candle via the candle flicker circuit 42; the integrated flame portion and body 20 can be made from a common thermoplastic material, such as PVC, PS, acrylic, or other like materials, with an opaque color such as white; the second bottom cap 32 is a circular cap with threads on the bottom along with a sealing o-ring to prevent water leakage; the transistor 40 can be in the form of a PNP BJT; the resistor 45 is 1M; the switch mechanism 50 can be in the form of a pair of heads on a thin nail body in which the heads are protruding out corresponding to the bottom surface of the second bottom cap 32. In addition, the electronic candle according to the second embodiment of the present invention contains one 3V lithium cell battery for use as the second battery 36. Meanwhile, the second bottom cap 32 can also a screw-on plastic cap with threads and a rubber o-ring for ensuring waterproof containment of the internal components after assembly.

Although the present invention has been described with reference to the embodiments thereof, it is apparent to those skilled in the art that a variety of modifications and changes may be made without departing from the scope of the present invention which is intended to be defined by the appended claims.

What is claimed is:

1. A floating electronic candle, comprising:
a color-changing LED bulb with an IC unit;
an integrated flame portion and body;
an external wax shell;
a first bottom cap; and
a switch mechanism, wherein the switch mechanism is to turn on the floating electronic candle automatically when floating on a liquid, and to turn off the electronic candle automatically when the electronic candle is removed from the liquid.

2. The floating electronic candle as claimed in claim 1, further comprising:
a plurality of first batteries;
a transistor; and
a resistor.

3. The floating electronic candle as claimed in claim 2, wherein the first batteries are a plurality of alkaline button cells.

4. The floating electronic candle as claimed in claim 1, wherein the color-changing LED bulb with the IC unit is to emit a red, green, and blue light.

5. The floating electronic candle as claimed in claim 4, wherein the color-changing LED bulb with the IC unit changes emitting color via a gradual smooth transition.

6. The floating electronic candle as claimed in claim 1, wherein the external wax shell comprising the shape of a plurality of flower petals.

7. The floating electronic candle as claimed in claim 1, wherein the switch mechanism is in the form of a pair of metal heads providing the terminals for forming a completed circuit upon coming into contact with the liquid.

8. The floating electronic candle as claimed in claim 1, wherein the flame portion of the integrated flame portion and body is protruded out of the top opening of the external wax shell.

9. The floating electronic candle as claimed in claim 1, wherein the first bottom cap comprising a rubber o-ring disposed along the inner periphery below a threaded portion.

10. A floating electronic candle, comprising:
an LED bulb;
an integrated flame portion and body;
a second bottom cap;
a candle flicker circuit; and
a switch mechanism, wherein the switch mechanism is to turn on the floating electronic candle automatically when floating on a liquid, and to turn off the electronic candle automatically when the electronic candle is removed from the liquid.

11. The floating electronic candle as claimed in claim 10, further comprising:
a second battery;
a transistor; and
a resistor.

12. The floating electronic candle as claimed in claim 11, wherein the second battery is a lithium cell battery.

13. The floating electronic candle as claimed in claim 10, wherein the candle flicker circuit is coupled to the LED bulb to provide the simulating effects of a wax candle flame

14. The floating electronic candle as claimed in claim 10, wherein the integrated flame portion and body is of an opaque color and is made of PVC, PE, PP, PS, acrylic, or PET.

15. The floating electronic candle as claimed in claim 10, wherein the switch mechanism is in the form of a pair of metal heads providing the terminals for forming a completed circuit upon coming into contact with the liquid.

16. The floating electronic candle as claimed in claim 10, wherein the second bottom cap comprising a rubber o-ring disposed along the inner periphery below a threaded portion.
